(19) United States
(12) Patent Application Publication
(10) Pub. No.: US 2009/0163138 A1
(43) Pub. Date: Jun. 25, 2009

(54) HYBRID TERRESTRIAL-SATELLITE TELECOMMUNICATIONS NETWORK WITH ADAPTABLE TERRESTRIAL RELAY-STATIONS

(75) Inventors: Emilio CALVANESE STRINATI, Grenoble (FR); Mathieu Des Noes, Grenoble (FR); Nicolas Cassiau, Saint Etienne De Crossey (FR)

Correspondence Address: LOWE HAUPTMAN & BERNER, LLP, 1700 DIAGONAL ROAD, SUITE 300, ALEXANDRIA, VA, 22314, US

(73) Assignee: COMMISSARIAT A L'ENERGIE ATOMIQUE, Paris (FR)

(21) Appl. No.: 12/339,175

(22) Filed: Dec. 19, 2008

(30) Foreign Application Priority Data
Dec. 21, 2007 (FR) 07 09062

(51) Int. Cl. H04B 7/185

(52) U.S. Cl. 455/12.1

(57) ABSTRACT

The general field of the invention is that of hybrid telecommunication networks comprising at least one telecommunication relay-satellite emitting at least one signal covering a given geographical zone organized into sub-zones of smaller dimension, a terrestrial relay-station able to receive, to process the satellite signal and to emit a signal in at least one of the sub-zones and mobile reception terminals. The network according to the invention comprises first means making it possible to carry out a mapping of the quality of reception of the satellite signal in each sub-zone; second means making it possible to transmit the mapping information to the terrestrial relay-station. The relay-station comprises third means making it possible, as a function of the reception mapping information, to emit a signal dependent on the said mapping making it possible to improve the quality of reception in its reception sub-zone.

### RELATED APPLICATIONS

The present application is based on, and claims priority from, French Application Number 07 09062, filed Dec. 21, 2007, the disclosure of which is hereby incorporated by reference herein in its entirety.

### BACKGROUND OF THE INVENTION

1. Field of the Invention

The field of the invention is that of hybrid terrestrial-satellite networks comprising terrestrial retransmission relay-stations.

2. Background of the Invention

To accompany the growing demand for telecommunications with global geographical coverage, in particular destined for mobile terminals such as portable telephones, networks comprise satellites which play an increasingly significant role in the new global telecommunication infrastructures. Thus, normalization standards such as that of third generation mobile telephony also called “3GPP”, standing for “3rd Generation Partnership Project” or the “DVB-H” standard, the acronym standing for “Digital Video Broadcasting—Handheld”, define communication networks that include satellites. By way of example, the Satellite-UMTS standard, standing for “Universal Mobile Telecommunications System” was the first technical standard approved by the “ETSI” (European Telecommunications Standards Institute) at the end of the year 2000.

The increasingly significant development in regard to satellites in terrestrial telecommunication systems gives rise to new problems in the structuring and configuring of networks. Specifically, a satellite covers a certain number of geographical reception areas called “cells”. Depending on the various retransmission scenarios, there exist unsuitable coverage zones where a cell or a space between two cells cannot be covered by the neighbouring cells. Such phenomena are typically due to the disturbances related to the geographical relief, to large-size buildings or to poor meteorological conditions.

These unsuitable coverage zones can impair the quality of the signal received by the subscriber's terminal and also decrease the ability of the network to manage and avoid interrupts. Thus, in the geographical zones where the network coverage is low, the service may thus no longer satisfy the user.

For terrestrial communication systems, several solutions have been proposed for alleviating these drawbacks. Patents U.S. Ser. No. 09/186,886 entitled “Poor network coverage mapping” from the company Ericsson and U.S. Pat. No. 6,799,016 entitled “Method for mapping poor coverage networks” from the company Motorola will be cited in regard to this matter.

In order to overcome the poor retransmission conditions, it has also been proposed to utilize various techniques for improving the coverage of a network of satellites. Having regard to their very wide bandwidth, the channels of the satellites do not offer the great diversity of frequencies which is usually exploited in terrestrial systems of “WCDMA” type, the acronym standing for “Wideband Code Division Multiple Access”, a system based on the technology used for third-generation mobile telephony and which implements terminals of “RAKE” type. Nevertheless, other techniques have been investigated. The publications by R. Tesi, L. Mucchi, Dj. Tujkovic and E. Kunnari entitled “Transmit diversity of Multi-satellite UMTS”, International Symposium on 3^{rd} Generation Infrastructure and Services 3GIS'01, Athens, Greece, July 2001 and by Thomas E. Sharon et al, 2004 entitled “Multi-beam satellite communications system” will be cited in regard to these matters.

Other projects are aimed at putting in place hybrid networks comprising ground relay stations. By way of example of hybrid networks comprising both satellites and terrestrial networks for distributing television and telecommunication services, the aim of the European project dubbed “IST MAESTRO” (IST standing for “Information Society Technology”) is to define, develop and put in place a new system called “SDMB”, the acronym standing for “Satellite Digital Multimedia Broadcast” using the “UMTS” standard. The “SDMB” system is intended to supplement the “UMTS” terrestrial mobile network with increased capabilities for distributing multimedia services, television or telecommunication channels to mobile systems, without introducing heavy constraints on the user's or subscriber's terminal. This hybrid architecture currently represents the best technological compromise for networks implementing both satellite coverage and terrestrial relays termed “point-to-point”. To provide service capabilities at low throughput protected from the disturbances from the relief, the MAESTRO architecture provides an improved bidirectional link with the satellite.

In conclusion, the objective of the MAESTRO project is to derive advantage from satellite systems and to ensure that the envisaged “SDMB” system is fully interoperational with the “UMTS” terrestrial standards so as to encourage the adoption of multimedia in Europe and to contribute to the successful deployment of the so-called “3G” standard.

The channels of mobile telecommunication systems may exhibit “fading”, that is to say a momentary weakening of the signal received. So, a protocol called “CSI”, standing for “Channel State Information” relating to the quality of the source-recipient linkup ought to be adopted so as to dynamically adapt the transmission parameters to the context of the temporal variations in transmission. Conventional wireless networks use a feedback channel to dispatch information of this type to the sender. Nevertheless, a characteristic of a satellite is that of broadcasting information to a very large number of users, so such “feedback” is not easy to collect. Moreover, it is not simple to ensure that such return signals are devoid of errors and any return signal is prone to significant lags in transmission to the source.

In terrestrial networks with fixed topology, a so-called “heuristic” approach for limiting the use of the feedback signals is to undertake a geometrical or geographical analysis of the network and to determine the zones where various techniques can deputize for the poor reception conditions. For example, the publication by E. Yazdan and M. R. Pakravan entitled “Adaptive Modulation Techniques for Cooperative Diversity in Wireless Fading Channels”, published in “IEEE International Symposium on Personal, Indoor, and Mobile Radio Communications, September 2006” describes the improvement in performance as a function of cooperation of the location of the users so as to identify the zones where the cooperation with the networks of ground relay stations becomes useful. Nevertheless, this network model with given topology may not be applied simply to a network of mobile wireless terminals.

Currently, in a telecommunications system comprising a certain number of communication satellites, a number of ground relay stations and a certain number of fixed or mobile terminals, there exist zones covered by the satellite where reception by the user's terminal is poor, others where it is more or less disturbed and, finally, others where it is satisfactory. Various degrees in the quality of reception of the signal can thus be defined. The quality of the signal is therefore not fixed when the mobile moves and depends on the geographical, morphological and local data. In addition to the momentary disturbances of the system due to interference, poor meteorological conditions can cause variations in the quality of the signal. For example, rain can cause an attenuation of between 8 dB and 10 dB for retransmission frequencies of between 12 GHz and 14 GHz. In this regard, the studies by G. Maral and M. Bousquet entitled “Satellite Communication Systems”, publisher John Wiley and Sons, 2^{nd} edition 1993, and by J. J. Spilker entitled “Digital Communication by Satellite”, publisher Prentice-Hall, 1977, will be cited.

It is therefore necessary for the system to possess the capability of differentiating the service offered to the terminals. The device according to the invention provides one or more adaptable terrestrial or “intelligent” relay-stations that can prescribe the terrestrial signal by dynamically selecting the sub-areas of the satellite coverage.

### SUMMARY OF THE INVENTION

More precisely, the subject of the invention is a hybrid telecommunication network comprising at least one telecommunication relay-satellite emitting at least one signal covering a given geographical zone organized into sub-zones of smaller dimension, a terrestrial relay-station able to receive, to process the satellite signal and to emit a signal in at least one of the sub-zones and mobile reception terminals, characterized in that:
The network comprises first means making it possible to carry out a mapping of the quality of reception of the satellite signal in each sub-zone;
The network comprises second means making it possible to transmit the mapping information to the terrestrial relay-station;
The relay-station comprises third means making it possible, as a function of the reception mapping information, to emit a signal dependent on the said mapping making it possible to improve the quality of reception in its reception sub-zone.

Advantageously, the mapping information is of two types, reception quality information due to the topography of the sub-zones and reception quality information due to the meteorological conditions.

Moreover, the quality of reception in each sub-zone can comprise at least three distinct levels:
First level: correct satellite reception of the reception terminals;
Second level: partial or fluctuating satellite reception of the reception terminals;
Third level: incorrect satellite reception of the reception terminals.

Advantageously, the network can comprise fourth means for controlling the emission signal of the terrestrial relay-station and fifth means making it possible to receive information from the mobile reception terminals.

Advantageously, the information received from the terminals relates to the quality of reception by the said terminals.

Moreover, the signal emitted by the station can be a destructive interference signal in regard to the satellite signal or a noisy interference signal so as to avoid correct reception in certain prohibited sub-zones.

Finally, the location of the terrestrial relay-station can be determined as a function of the mapping of the quality of reception of the satellite signal, the location possibly being definitive or temporary.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a global view of the network according to the invention;

FIGS. 2, 3 and 4 represent three modes of operation of the relay-station according to the invention.

### MORE DETAILED DESCRIPTION

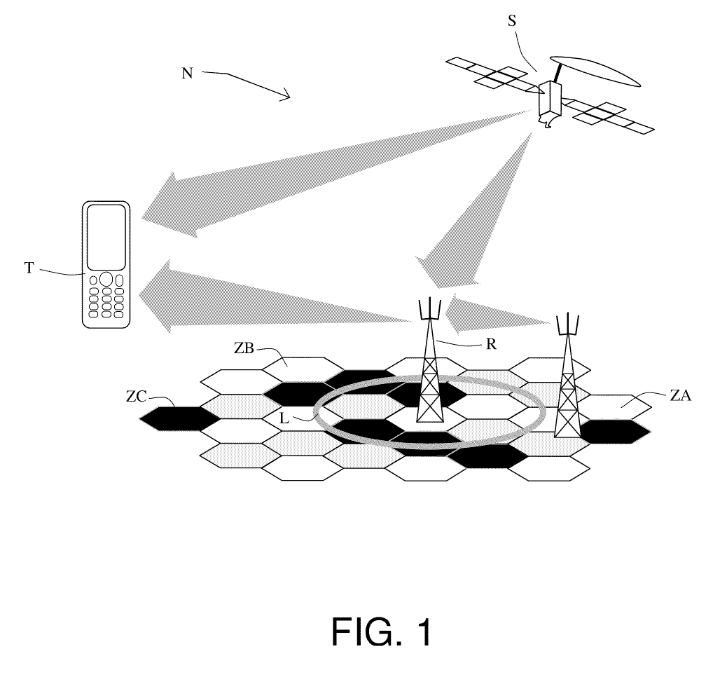

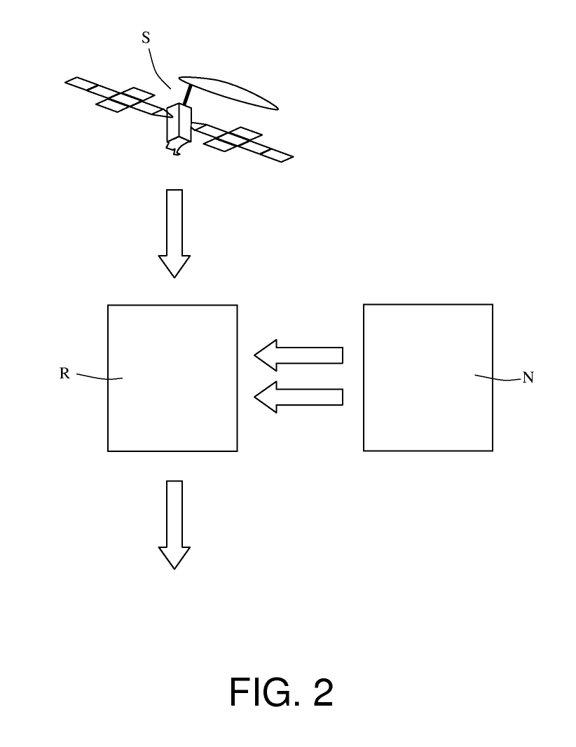

FIG. 1 represents a global view of the network N according to the invention. It comprises essentially:
a telecommunication relay-satellite S emitting at least one signal covering a given geographical zone organized into sub-zones of smaller dimension forming a grid,
at least one terrestrial relay-station R able to receive and process the satellite signal and
mobile reception terminals T.

The various signals emitted and received are represented by arrows comprising a wavy pattern in FIG. 1.

In FIG. 1, the sub-zones Z covered by the satellite are represented, by way of example, by hexagons. Of course, they could be a different shape. Bearing in mind the performance of relay-stations, the channel between the satellite and the relay station is always satisfactory or free of errors. On the other hand, as was stated, the reception by a mobile terminal, whose reception means are much less efficacious than those of a relay-station, may not be satisfactory. Retransmission quality varies as a function of the position of the terminal on the grid and/or of the temporal variations in retransmission which can depend, for example, on meteorological conditions.

Thus, seen from the terminals, the satellite signal is not of like quality in these various zones. By way of example, in FIG. 1, three types of zones have been distinguished, these being:
Type ZA (white): good satellite signal to the mobiles,
Type ZB (dotted): medium satellite signal with possibility of transmission errors for the mobiles,
Type ZC (black): poor satellite signal.

Measurement of the quality of reception in each zone does not pose any particular technical problems. The network then comprises means making it possible to carry out dynamic mapping of the quality of reception of the satellite signal in each sub-zone. This mapping can be carried out in two dimensions or in three dimensions.

It should be noted that the location of the relay-stations constituting a terrestrial network or the choice of the location of a new relay-station can be determined as a function of this mapping of reception quality.

The dotted ellipse of FIG. 1 represents the limit L of the coverage ensured by the relay station which is smaller than that of the satellite. For example, the coverage of the relay station can cover just one or a few zones. This coverage depends on the radiation pattern of the antennas of the relay and the emitted power.

The network comprises means making it possible to transmit the mapping information to the terrestrial relay-station. The relay-station then comprises means making it possible, as a function of the reception mapping information, to emit a signal dependent on the said mapping in such a way that the terminals situated in the zones where the retransmission is poor or zero can nevertheless receive correct information. To this end, the improvement means can be:
Means for differentiating the telecommunications information through the relay of local information,
Means for improving the quality of the signal of the terminal by adapting the transmission of the relay or by effecting cooperations between relay-stations.

The signal emitted by the relay-station can also be used to identify the coverage zones where reception is not desired or allowed. It is then possible to dispatch in such zones a destructive interference signal and/or a noisy interference signal so as to avoid correct reception of the satellite.

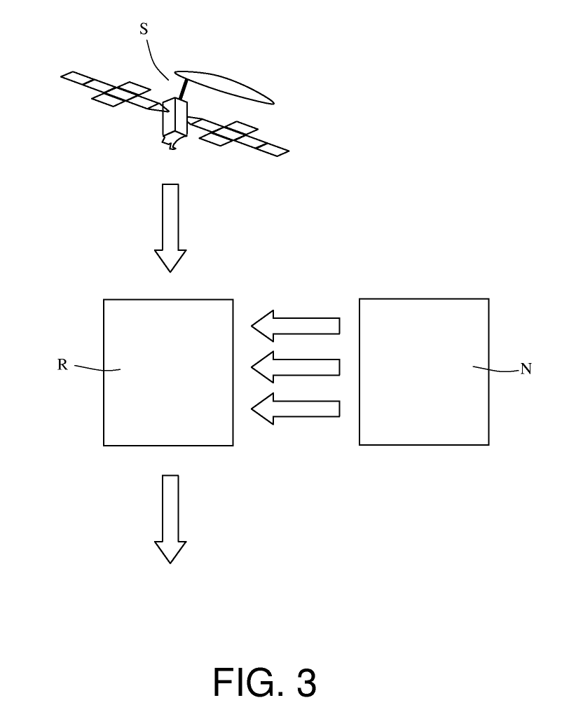

FIGS. 3, 4 and 5 represent three “intelligent” modes of ground relay-station operation according to the invention.

In these various figures, the various communication links are represented by white arrows.

In FIG. 3, the relay-station receives information:
From the satellite. The relay-station is arranged in such a way that the satellite reception conditions are always good, including in poor meteorological conditions;
From the network. This information is essentially the dynamic mapping of the quality of reception of the satellite signal in each sub-zone, the latter can comprise a part that does not vary over time, for example when the poor reception quality depends on the relief, and a part that varies over time, for example when the poor reception quality depends on the meteorological conditions.

The relay-station then emits information destined for the mobile terminals.

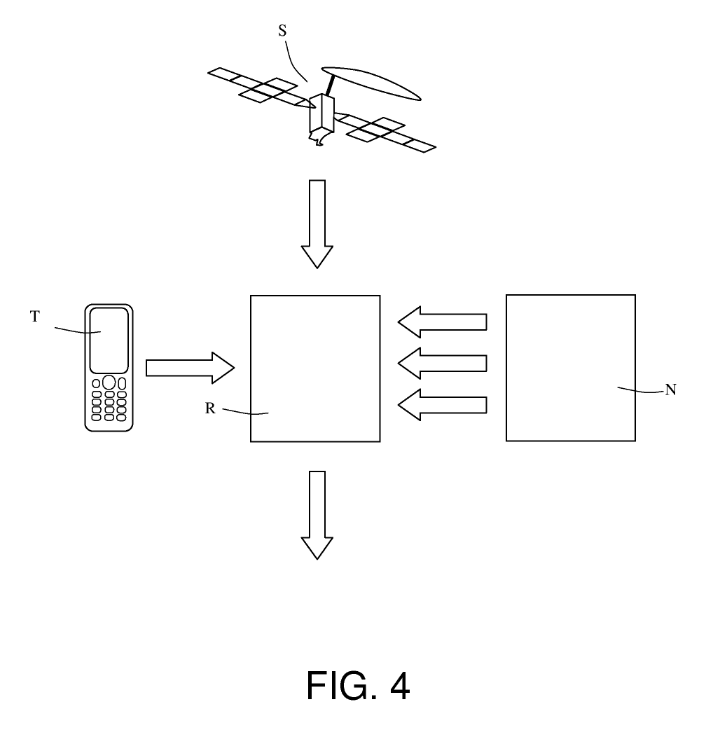

In FIG. 4, the relay-station moreover receives a control signal originating from the network; this signal may be a signal indicating to the relay-station the zones to be covered or its current coverage. This signal may also be a signal for turning the relay-station on or off in the case where it is not intended to be continually operational.

In FIG. 5, the relay-station also receives information coming from the terminals. This information is, for example, feedback information regarding the quality of reception (information regarding satisfaction or dissatisfaction) or the current coverage of the station.

The communications network according to the invention can be applied mainly to third-generation mobile systems such as “3GPP”, “DVB” broadcasting (or “Digital Video Broadcasting”) and to any telecommunication satellite network arranged according to a pattern making it possible to define a plurality of cells having overlap zones and which afford support to radio communications in a given geographical region.

It will be readily seen by one of ordinary skill in the art that the present invention fulfills all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

What is claimed is:

1. Hybrid telecommunication network comprising:
at least one telecommunication relay-satellite emitting at least one signal covering a given geographical zone organized into sub-zones of smaller dimension, a terrestrial relay-station able to receive, to process the satellite signal and to emit a signal in at least one of the sub-zones and mobile reception terminals, wherein:
the network comprises first means to carry out a mapping of the quality of reception of the satellite signal in each sub-zone;
the network comprises second means to transmit the mapping information to the terrestrial relay-station;
the relay-station comprises third means, as a function of the reception mapping information, to emit a signal dependent on the said mapping to improve the quality of reception in its reception sub-zone.

2. The network according to claim 1, wherein the mapping information is of two types, reception quality information due to the topography of the sub-zones and reception quality information due to the meteorological conditions.

3. The network according to claim 1, wherein the quality of reception in each sub-zone comprises at least three distinct levels:
first level: correct satellite reception of the reception terminals;
second level: partial or fluctuating satellite reception of the reception terminals;
third level: incorrect satellite reception of the reception terminals.

4. The network according to claim 1, wherein the network comprises fourth means for controlling the emission signal of the terrestrial relay-station.

5. The network according to claim 1, wherein the relay-station comprises fifth means to receive information from the mobile reception terminals.

6. The network according to claim 5, wherein the information received from the terminals relates to the quality of reception by the said terminals.

7. The network according to claim 1, wherein the signal emitted by the station is a destructive interference signal in regard to the satellite signal or a noisy interference signal so as to avoid correct reception in certain prohibited sub-zones.

8. The network according to claim 1, wherein the location of the terrestrial relay-station is determined as a function of the mapping of the quality of reception of the satellite signal, the location possibly being definitive or temporary.
